(19) United States
(12) Patent Application Publication
(10) Pub. No.: US 2026/0029608 A1
(43) Pub. Date: Jan. 29, 2026

(54) LENS UNIT

(71) Applicant: NIDEC INSTRUMENTS CORPORATION, Nagano (JP)

(72) Inventors: Tomoaki NAKAJIMA, Nagano (JP); Yasuhiro HOSHINA, Nagano (JP)

(73) Assignee: NIDEC INSTRUMENTS CORPORATION, Nagano (JP)

(21) Appl. No.: 19/348,746

(22) Filed: Oct. 2, 2025

Related U.S. Application Data
(63) Continuation of application No. PCT/JP2024/009741, filed on Mar. 13, 2024.

(30) Foreign Application Priority Data
Apr. 3, 2023 (JP) 2023-059824

(51) Int. Cl. G02B 7/02

(52) U.S. Cl. CPC G02B 7/021; G02B 7/025

(57) ABSTRACT

A lens unit includes a first lens barrel that houses a lens, and a second lens barrel that houses a lens and is held on an inner peripheral side of the first lens barrel. The second lens barrel includes, in an image-side portion of an outer peripheral surface, an outer peripheral surface image-side step portion having an annular surface that faces an image side. The first lens barrel has ribs that are in contact with the annular surface from the image side to position the second lens barrel in an optical axis direction, and object-side protrusions that are in contact with an end portion of the second lens barrel on an object side from outside in a radial direction to position the second lens barrel in the radial direction. An adhesive fixing portion is provided between the ribs and the object-side protrusions in the optical axis direction.

### CROSS-REFERENCE TO RELATED APPLICATION

This application is a continuation of PCT International Application No. PCT/JP2024/009741, filed on Mar. 13, 2024, which claims priority under 35 U.S.C § 119(a) to Japanese Patent Application No. 2023-059824, filed on Apr. 3, 2023. Each of the above application(s) is hereby expressly incorporated by reference, in its entirety, into the present application.

### BACKGROUND

### Technical Field

The present invention relates to a lens unit including a first lens barrel that houses a first lens, and a second lens barrel that houses a second lens disposed on an image side of the first lens.

### Description of Related Art

Such a lens unit is described in Patent Literature 1 (Japanese Patent Application Laid-Open No. 2019-203907). In the document, a first lens barrel includes a step portion in an intermediate portion of an inner peripheral surface in an optical axis direction. The step portion has a receiving portion that faces an object side, and a small-diameter portion that faces inward in a radial direction on an image side of a supported portion.

On the other hand, a second lens barrel (lens holding ring) includes, on an outer peripheral surface, a step portion that is fitted to the step portion of the first lens barrel. The step portion of the second lens barrel has the supported portion that faces the image side, and a fitting portion that faces outward in the radial direction. The supported portion is in close contact with the receiving portion in the optical axis direction and the fitting portion is in close contact with the small-diameter portion to hold the second lens barrel on the inner peripheral side of the first lens barrel.

In a lens unit including lens barrels composed of two members, it is preferable that no tilting occurs between a first lens barrel and a second lens barrel held by the first lens barrel. This is because if tilting occurs between the first lens barrel and the second lens barrel, an optical axis of a lens group held by the second lens barrel is inclined with respect to an optical axis of a lens held by the first lens barrel.

The present invention provides a lens unit capable of preventing or suppressing the occurrence of tilting between a first lens barrel and a second lens barrel held by the first lens barrel.

### SUMMARY

A lens unit of the present invention includes: a first lens; a second lens that is disposed on an image side of the first lens; a first lens barrel that houses the first lens; and a second lens barrel that houses the second lens and is held on an inner peripheral side of the first lens barrel, wherein the second lens barrel includes, in an image-side portion of an outer peripheral surface, a first step portion having a first annular surface that faces the image side and a first outer peripheral surface portion that extends from an outer peripheral end of the first annular surface to an object side, when a direction along an optical axis of the first lens is defined as an optical axis direction, the first lens barrel has a first positioning portion that is in contact with the first annular surface from the image side to position the second lens barrel in the optical axis direction, and a second positioning portion that is in contact with an end portion of the second lens barrel on the object side from outside in a radial direction to position the second lens barrel in the radial direction, and an adhesive fixing portion that connects the first lens barrel to the second lens barrel via an adhesive layer is provided between the first positioning portion and the second positioning portion in the optical axis direction.

According to the present invention, the second lens barrel that houses the second lens includes, in the image-side portion of the outer peripheral surface, the first step portion having the first annular surface facing the image side. On the other hand, the first lens barrel that houses the first lens has the first positioning portion that is in contact with the first annular surface from the image side to position the second lens barrel in the optical axis direction, and the second positioning portion that is in contact with the end portion of the second lens barrel on the object side from outside in the radial direction to position the second lens barrel in the radial direction. Thus, when the second lens barrel is held by the first lens barrel, the second lens barrel is positioned in the optical axis direction at the end portion of the second lens barrel on the image side in the optical axis direction, and is positioned in the radial direction at the end portion of the second lens barrel on the object side in the optical axis direction. Both end portions of the second lens barrel in the optical axis direction are positioned by the first positioning portion and the second positioning portion provided in the first lens barrel; thus, it is possible to prevent or suppress the occurrence of tilting of the second lens barrel. Furthermore, the second positioning portion that positions the second lens barrel in the radial direction is located on the object side; thus, the optical axis of the first lens held by the first lens barrel is more likely to coincide with the optical axis of the second lens held by the second lens barrel. Furthermore, the adhesive fixing portion that connects the first lens barrel to the second lens barrel via the adhesive layer is provided between the first positioning portion and the second positioning portion in the optical axis direction; thus, after completion of the positioning of the second lens barrel in the optical axis direction and the radial direction by the first positioning portion and the second positioning portion, it is possible to fix the first lens barrel and the second lens barrel by the adhesive.

In the present invention, the lens unit may be configured to include a laminated body in which optical members including multiple lenses are laminated and configured such that the laminated body is housed in the second lens barrel on the image side of the second lens. When the second lens and the laminated body are housed in the second lens barrel, the second lens barrel is more likely to be long in the optical axis direction. Thus, if tilting of the second lens barrel occurs, the optical axis is inclined between the first lens and the laminated body, and deterioration in the optical performance is more likely to occur. However, both end portions of the second lens barrel in the optical axis direction are positioned by the first positioning portion and the second positioning portion provided in the first lens barrel; thus, it is possible to prevent or suppress the occurrence of tilting of the second lens barrel. This makes it possible to suppress deterioration in the optical performance.

In the present invention, the lens unit may be configured such that the first lens barrel has, on an inner peripheral surface, an annular first facing surface portion that faces the first annular surface in the optical axis direction and an annular second facing surface portion that faces the end portion of the second lens barrel on the object side in the radial direction, first protrusions that protrude in the optical axis direction at multiple positions in a circumferential direction are provided in the first facing surface portion, second protrusions that protrude to the inner peripheral side at multiple positions in the circumferential direction are provided in the second facing surface portion, the first positioning portion includes the first protrusions, and the second positioning portion includes the second protrusions. With this configuration, it is possible to accurately position the first lens barrel and the second lens barrel in the optical axis direction as compared with a case where the first lens barrel and the second lens barrel are positioned in the optical axis direction by bringing the first annular surface into surface contact with the annular first facing surface portion. Furthermore, it is possible to accurately position the first lens barrel and the second lens barrel in the radial direction as compared with a case where the first lens barrel and the second lens barrel are positioned in the radial direction by bringing the end portion of the second lens barrel on the object side into surface contact with the annular second facing surface portion.

In the present invention, the lens unit may be configured such that the second lens barrel includes, between an end portion of the outer peripheral surface on the object side and the first step portion, a second step portion having a second annular surface that faces the image side and a second outer peripheral surface portion that extends from an inner peripheral end of the second annular surface to the image side, the first lens barrel includes, on the inner peripheral surface, a first lens barrel-side step portion having an annular first facing surface that faces the second annular surface and a step portion wall surface that extends from an inner peripheral end of the first facing surface to the image side, and the adhesive layer is interposed between the second annular surface and the first facing surface and between the second outer peripheral surface portion and the step portion wall surface. With this configuration, it is possible to form the adhesive layer by applying an adhesive to the first facing surface on the inner peripheral surface of the first lens barrel from the object side.

In the present invention, the lens unit may be configured such that the first lens barrel-side step portion has, multiple positions in the circumferential direction, notched grooves that extend in the optical axis direction and divide the first facing surface and the step portion wall surface in the circumferential direction. With this configuration, no adhesive is applied to the portions of the first lens barrel-side step portion in which the notched grooves are provided. Therefore, the first lens barrel and the second lens barrel are connected via the adhesive layer, except for the portions in which the notched grooves are formed.

In the present invention, the lens unit may be configured to include an O-ring that is provided on an outer peripheral side of the second lens barrel and is in contact with the first lens from the image side, and configured such that the first lens barrel has an annular caulking portion that is bent from a tip portion of the first lens barrel on the object side to the inner peripheral side and is in contact with an outer peripheral end portion of the first lens from the object side, and an annular support surface that faces the object side at a position overlapping with the caulking portion as viewed from the optical axis direction, the outer peripheral end portion of the first lens is located between the caulking portion and the support surface, the O-ring is compressed in the optical axis direction between the outer peripheral end portion of the first lens and the support surface, the second facing surface portion extends from an inner peripheral end of the support surface to the image side, and an air passage is formed between the first lens barrel and the second lens barrel, the air passage passing through a gap between an end of the first lens barrel on the image side and an end of the second lens barrel on the image side, a gap between the first protrusions adjacent to each other in the circumferential direction, the notched grooves, and a gap between the second protrusions adjacent to each other in the circumferential direction, the air passage communicating with a space that is located between the first lens and the support surface and is closer to the inner peripheral side than the O-ring. With this configuration, it is possible to blow air into a portion between the end of the first lens barrel on the image side and the end of the second lens barrel on the image side to check whether a portion between the outer peripheral end portion of the first lens and the support surface is liquid tightly sealed by the O-ring.

### BRIEF DESCRIPTION OF THE DRAWINGS

FIG. 1 is a perspective view of an external appearance of a lens unit to which the present invention is applied.

FIG. 2 is a cross-sectional view of the lens unit.

FIG. 3 is an exploded perspective view of the lens unit.

FIG. 4 is an exploded perspective view of a lens L3 and a lens L4 as viewed from an object side.

FIG. 5 is an exploded perspective view of the lens L3 and the lens L4 as viewed from an image side.

FIG. 6 is an exploded perspective view of a lens L5 and a lens L6 as viewed from the object side.

FIG. 7 is an exploded perspective view of the lens L5 and the lens L6 as viewed from the image side.

FIG. 8 is a perspective view of a holder, the lens L5, and the lens L6.

FIG. 9 is a cross-sectional view of a first lens barrel.

FIG. 10 is a perspective view of a second lens barrel as viewed from the object side.

FIG. 11 is a cross-sectional view of the second lens barrel.

FIG. 12 is an explanatory diagram of a method of aligning the lens L6 with the lens L5.

### DESCRIPTION OF THE EMBODIMENTS

According to the lens unit of the present invention, when the second lens barrel is held by the first lens barrel, the second lens barrel is positioned in the optical axis direction at the end portion of the second lens barrel on the image side in the optical axis direction, and is positioned in the radial direction at the end portion of the second lens barrel on the object side in the optical axis direction. Both end portions of the second lens barrel in the optical axis direction are positioned by the first positioning portion and the second positioning portion provided in the first lens barrel; thus, it is possible to prevent or suppress the occurrence of tilting of the second lens barrel. Furthermore, the second positioning portion that positions the second lens barrel in the radial direction is located on the object side; thus, the optical axis of the lens held by the first lens barrel is more likely to coincide with the optical axis of the lens group held by the second lens barrel. Furthermore, the adhesive fixing portion that connects the first lens barrel to the second lens barrel via the adhesive layer is provided between the first positioning portion and the second positioning portion in the optical axis direction; thus, after completion of the positioning of the second lens barrel in the optical axis direction and the radial direction by the first positioning portion and the second positioning portion, it is possible to fix the first lens barrel and the second lens barrel by the adhesive.

An embodiment of a lens unit to which the present invention is applied will be described below with reference to the drawings.

### Optical System

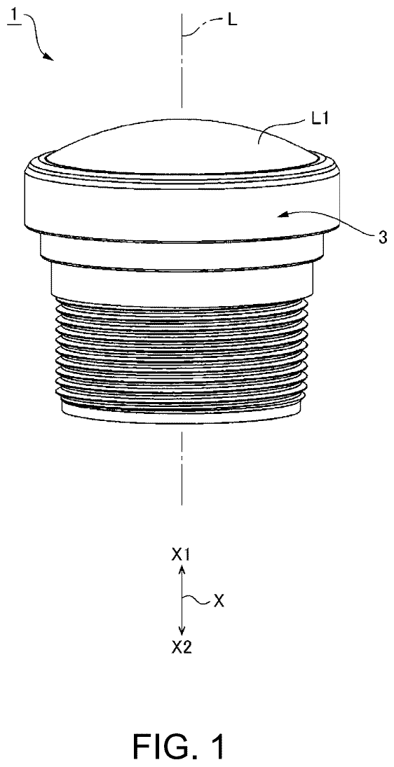

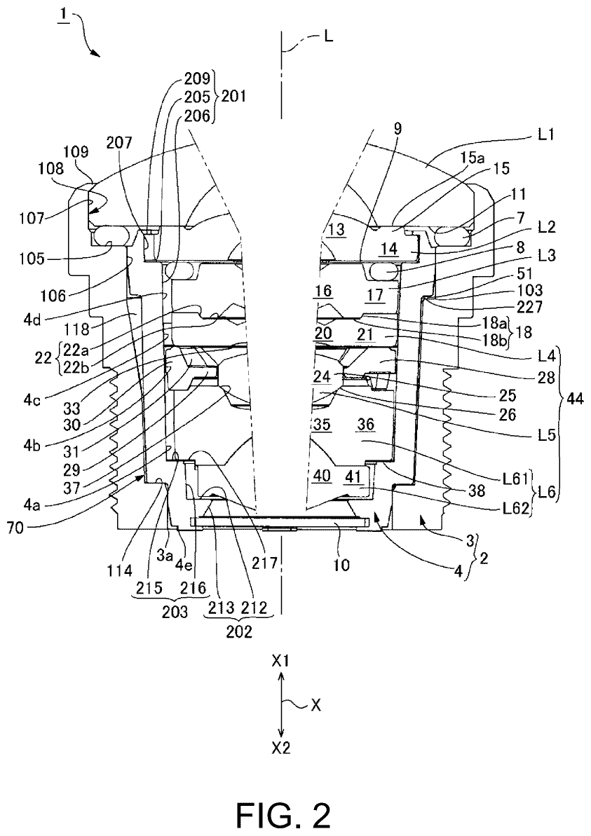

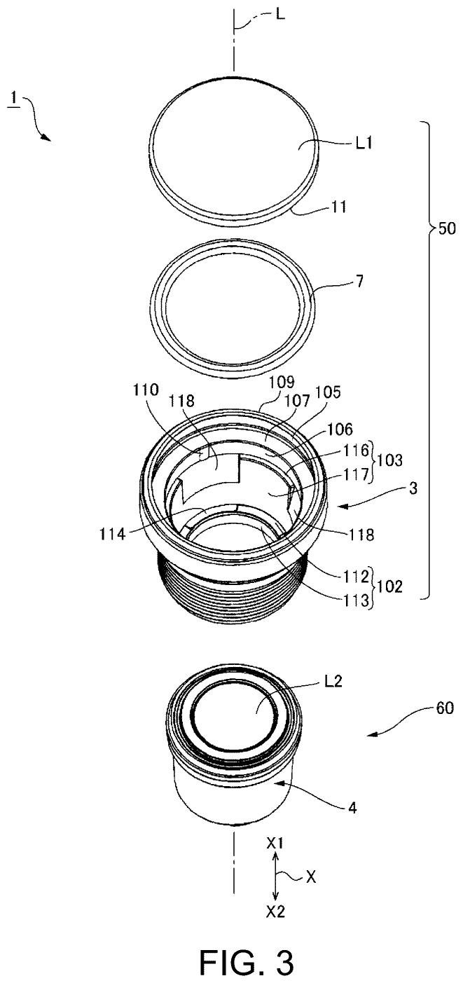

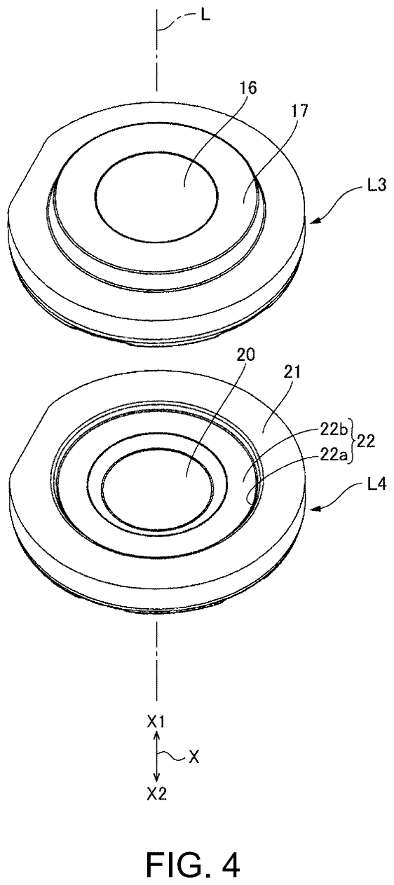

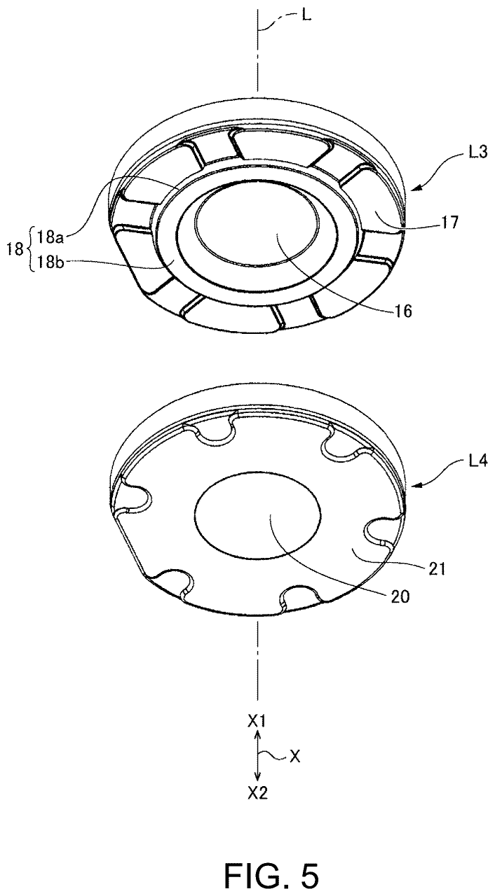

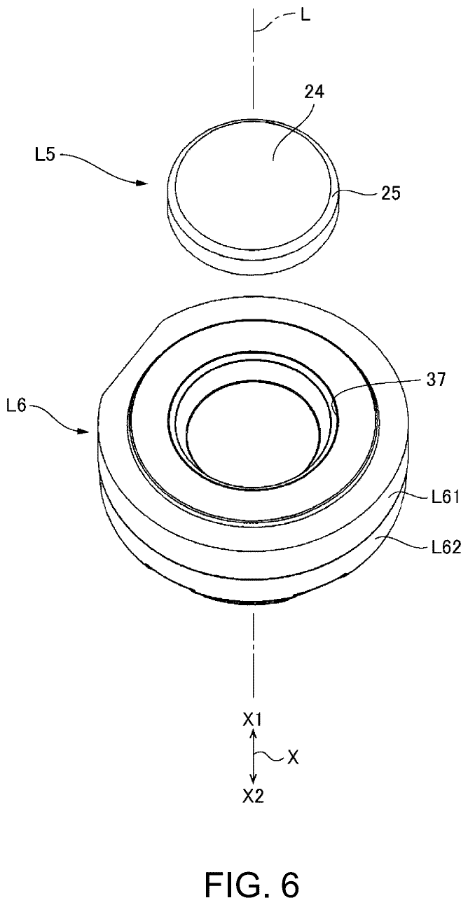

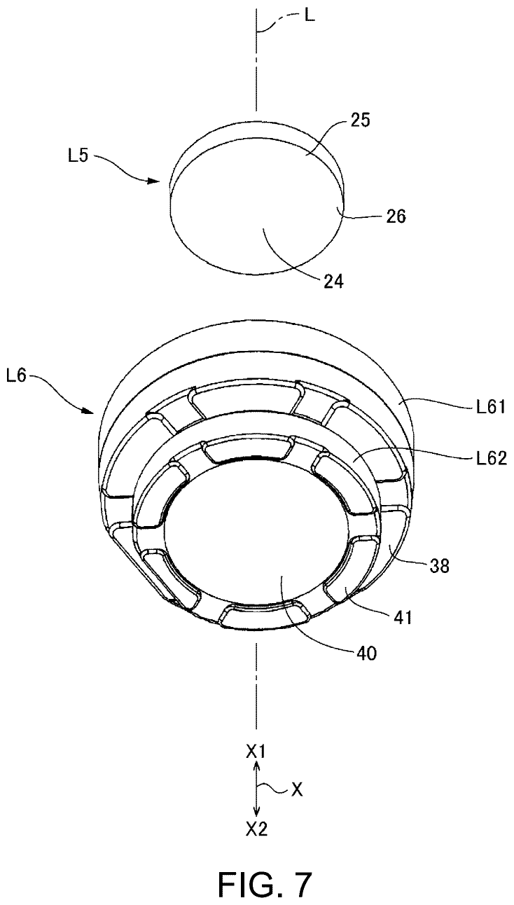

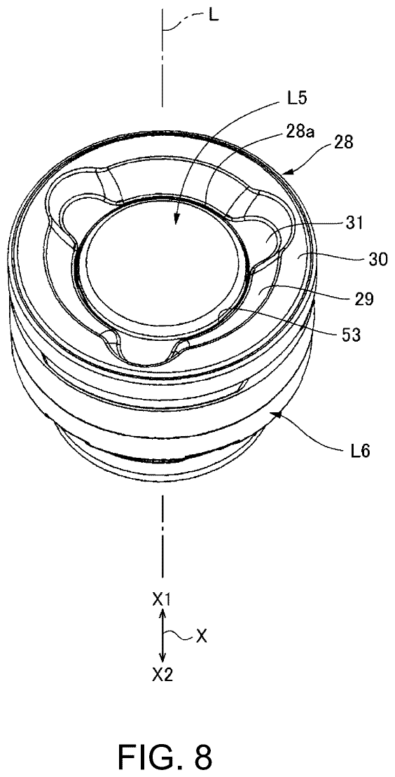

FIG. 1 is a perspective view of an external appearance of a lens unit to which the present invention is applied. FIG. 2 is a cross-sectional view of the lens unit. FIG. 3 is an exploded perspective view of the lens unit. FIG. 4 is an exploded perspective view of a lens L3 and a lens L4 as viewed from an object side. FIG. 5 is an exploded perspective view of the lens L3 and the lens L4 as viewed from an image side. FIG. 6 is an exploded perspective view of a lens L5 and a lens L6 as viewed from the object side. FIG. 7 is an exploded perspective view of the lens L5 and the lens L6 as viewed from the image side. FIG. 8 is a perspective view of a holder, the lens L5, and the lens L6. In FIG. 2, the shapes of lenses are not shown in a region (around an optical axis) between two dash-dot-dot lines.

A lens unit 1 according to this example illustrated in FIG. 1 is used in an imaging device mounted on an automobile or a surveillance camera. As illustrated in FIG. 2, the lens unit 1 includes a lens L1, a lens L2, the lens L3, the lens L4, the lens L5, and the lens L6 in this order from the object side toward the image side. The lens L6 is a cemented lens, and includes an object-side lens L61 and an image-side lens L62 in this order from the object side toward the image side. Furthermore, the lens unit 1 includes, as portions of a lens barrel 2, a first lens barrel 3 and a second lens barrel 4 that is held on the inner peripheral side of the first lens barrel 3. The lens L1 is housed in the first lens barrel 3. The lenses L2 to L6 are housed in the second lens barrel 4. The second lens barrel 4 is held on the inner peripheral side of the first lens barrel 3.

As illustrated in FIG. 3, the lens L1 and the first lens barrel 3 constitute a first unit 50. The lenses L2 to L6 and the second lens barrel 4 constitute a second unit 60. Hereinafter, a direction along an optical axis L of the lens L1 is referred to as an optical axis direction X. The optical axis L of the lens L1 is the optical axis L of the lens unit 1. In the optical axis direction X, an object side X1 is the side on which the lens L1 is located, and an image side X2 is the side on which the lens L6 is located.

As illustrated in FIG. 2, the lens L1 has a larger outer diameter than the lenses L2 to L6. In this example, the lens L1 is made of glass. The lens L1 is a meniscus lens having a convex shape on the object side X1. The lens L1 has, on the outer peripheral side of a lens surface on the image side X2, an annular end surface 11 that extends in a direction orthogonal to the optical axis L. A first O-ring 7 is disposed on the image side X2 of the end surface 11 of the lens L1.

The lens L2 is made of resin. The lens L2 includes a lens body portion 13 having lens surfaces, and a flange portion 14 surrounding the lens body portion 13. The lens L2 is a meniscus lens having a convex shape on the object side X1. An annular protruding portion 15 that protrudes to the object side X1 is provided on an end surface of the flange portion 14 on the object side X1. A tip of the annular protruding portion 15 is an annular contact portion 15a that is in surface contact with the end surface of the lens L1.

As illustrated in FIGS. 2, 4, and 5, the lens L3 is made of resin. The lens L3 includes a lens body portion 16 having lens surfaces, and a flange portion 17 surrounding the lens body portion 16. The lens L3 is a meniscus lens having a convex shape on the image side X2. As illustrated in FIG. 5, an annular fitting portion 18 that protrudes to the object side X1 is provided on an end surface of the flange portion 17 on the image side X2. The fitting portion 18 has a fitting portion tapered surface 18a that surrounds the optical axis L and is inclined to the inner peripheral side toward the image side X2, and a fitting portion end surface 18b that extends perpendicular to the optical axis L from an end of the fitting portion tapered surface 18a on the image side X2 toward the inner peripheral side.

Here, as illustrated in FIG. 2, an elastic member is disposed between the lens L2 and the lens L3 in the optical axis direction X. The elastic member is a second O-ring 8. The second O-ring 8 is compressed in the optical axis direction X between the flange portion 14 of the lens L2 and the flange portion 17 of the lens L3. In this example, a light shielding sheet 9 made of resin is disposed between the lens L1 and the lens L2 in the optical axis direction X. The light shielding sheet 9 has an annular shape. The second O-ring 8 is located between the light shielding sheet 9 and the lens L3.

The lens L4 is made of resin. As illustrated in FIGS. 2, 4, and 5, the lens L4 includes a lens body portion 20 having lens surfaces, and a flange portion 21 surrounding the lens body portion 20. In the lens L4, the lens surface of the lens body portion 20 on the object side X1 is a curved surface protruding to the object side X1. The lens surface of the lens body portion 20 on the image side X2 has, in a center of the lens surface, a curved surface portion protruding to the image side X2.

As illustrated in FIG. 4, a fitted portion 22 to which the fitting portion 18 of the lens L3 is fitted is provided on an end surface of the flange portion 21 on the object side X1. The fitted portion 22 has a fitted portion tapered surface 22a that surrounds the optical axis L and is inclined to the inner peripheral side toward the image side X2, and a fitted portion end surface 22b that extends perpendicular to the optical axis L from an end of the fitted portion tapered surface 22a on the image side X2 toward the inner peripheral side. As illustrated in FIG. 2, the fitting portion tapered surface 18a of the lens L3 is in surface contact with the fitted portion tapered surface 22a of the lens L4. The fitting portion end surface 18b of the lens L3 is separated from the fitted portion end surface 22b of the lens L4 in the optical axis direction X. In this example, an end surface of an outer peripheral side portion of the fitting portion 18 on the image side X2 in the flange portion 17 of the lens L3 is in contact in the optical axis direction X with an end surface of an outer peripheral side portion of the fitted portion 22 on the object side X1 in the flange portion 21 of the lens L4. Thus, the lens L3 is placed on the lens L4 to be positioned in the optical axis direction X.

The lens L5 is made of glass. As illustrated in FIG. 2, the lens L5 has a smaller outer diameter than the lens L2, the lens L3, the lens L4, and the lens L6. The lens L5 includes a lens body portion 24 having lens surfaces, and a flange portion 25 surrounding the lens body portion 24. The lens L5 is a biconvex lens. As illustrated in FIGS. 2 and 7, a portion of the flange portion 25 on the image side X2 is a contact portion 26 that is in contact with the lens L6 from the object side X1. A cross section of the contact portion 26 cut along the optical axis L has an arc shape curved to the object side X1 toward the outer peripheral side. As illustrated in FIG. 7, a surface of the contact portion 26 on the image side X2 is continuous, without a step, with an outer peripheral end of a lens surface 24a of the lens body portion 24 on the image side X2.

As illustrated in FIG. 2, a holder 28 made of resin is disposed outside the lens L5 in the radial direction. As illustrated in FIG. 8, the holder 28 has an annular shape. The holder 28 includes a central portion 29 that is adjacent to the lens L5 with a gap 28a in the radial direction, and an outer peripheral portion 30 that is provided on the outer peripheral side of the central portion 29 and is thicker in the optical axis direction X than the central portion 29. A surface of the central portion 29 on the object side X1 is inclined to the image side X2 from the outer peripheral portion 30 toward the inner peripheral side. Notched portions 31 that are notched from the object side X1 and the inner peripheral side are provided at three positions in a circumferential direction in the central portion 29 and the outer peripheral portion 30. A bottom surface (surface facing the object side X1) of each of the notched portions 31 is continuous with an inner peripheral end edge of the central portion 29.

Here, a diaphragm 33 is disposed between the lens L4 and the lens L5. The diaphragm 33 is an annular sheet, and is sandwiched between the lens L4 and the holder 28 and is supported at a predetermined position in the optical axis direction X.

The lens L6 is made of resin. That is, the object-side lens L61 and the image-side lens L62 are both made of resin. As illustrated in FIG. 2, the object-side lens L61 includes a lens body portion 35 having lens surfaces, and a flange portion 36 surrounding the lens body portion 35. The lens surface of the object-side lens L61 on the object side X1 is a curved surface curved to the image side X2, and the lens surface of the object-side lens L61 on the image side X2 is a curved surface recessed to the object side X1.

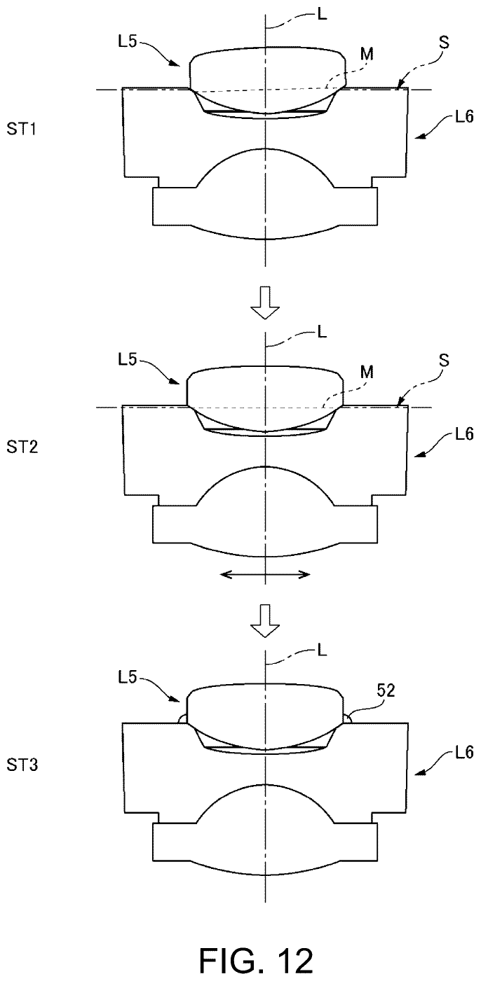

As illustrated in FIG. 6, the flange portion 36 of the object-side lens L61 has, on the object side X1, a contacted portion 37 with which the contact portion 26 of the lens L5 is in contact. The contacted portion 37 is a tapered surface extending to the object side X1 toward the outer peripheral side. The contact portion 26 is in line contact with the contacted portion 37. A contact line M on which the contact portion 26 is in contact with the contacted portion 37 has an annular shape whose axis coincides with the optical axis L and is located on a virtual vertical plane S that is perpendicular to the optical axis L (see FIG. 12 described below). Furthermore, the flange portion 36 of the object-side lens L61 has, on the image side X2, an annular end surface 38 that is perpendicular to the optical axis L.

The image-side lens L62 includes a lens body portion 40 having lens surfaces, and a flange portion 41 surrounding the lens body portion 40. The lens surface of the image-side lens L62 on the object side X1 is a curved surface protruding to the object side X1, and the lens surface of the image-side lens L62 on the image side X2 is a curved surface protruding to the object side X1. The image-side lens L62 is fixed to the object-side lens L61. The image-side lens L62 has a smaller outer diameter than the object-side lens L61. Thus, as illustrated in FIG. 7, as viewed from the image side X2, the flange portion 36 of the object-side lens L61 has a portion projecting from the image-side lens L62 to the outer peripheral side.

Here, as illustrated in FIG. 2, the lens L5 is stacked on the lens L6. Furthermore, the lens L4 is stacked on the lens L6 via the holder 28. The lens L4, the holder 28, the lens L5, and the lens L6 constitute a laminated body 44. The lens L3 is stacked on the lens L4. That is, the lens L3 is stacked on the laminated body 44. Furthermore, a plate-shaped cover 10 is disposed on the image side X2 of the lens L6.

### Lens Barrel

As illustrated in FIGS. 2 and 3, the lens unit 1 includes, as portions of the lens barrel 2, the first lens barrel 3 and the second lens barrel 4 held on the inner peripheral side of the first lens barrel 3. The first lens barrel 3 and the second lens barrel 4 are both made of resin. Furthermore, the first lens barrel 3 and the second lens barrel 4 are resin injection molded products molded by injecting resin into a mold. The lens L1 is housed in the first lens barrel 3. The lenses L2 to L6 and the holder 28 are housed in the second lens barrel 4. The second lens barrel 4 is held on the inner peripheral side of the first lens barrel 3.

### First Lens Barrel and Lens L1

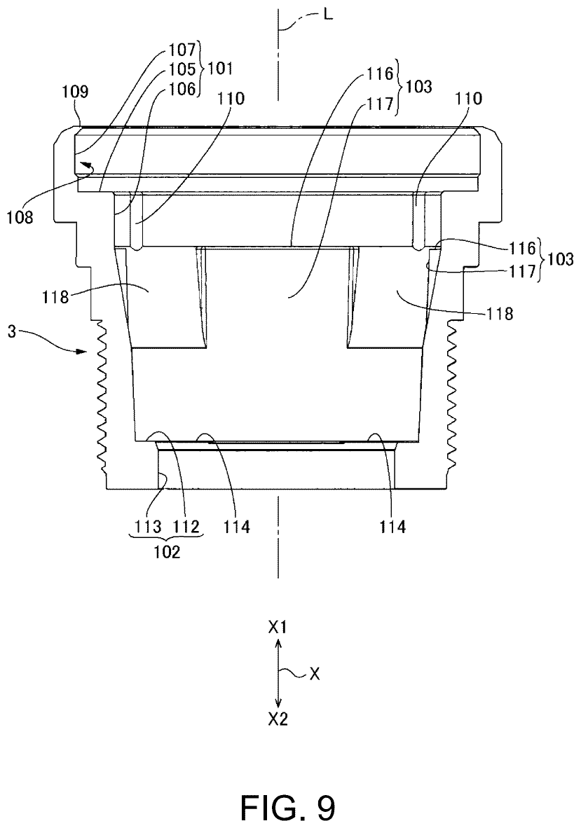

FIG. 9 is a cross-sectional view of the first lens barrel 3. The first lens barrel 3 has a cylindrical shape, and is located on the outer peripheral side of the lens L2, the lens L3, the lens L4, the holder 28, the lens L5, the lens L6, and the second lens barrel 4. As illustrated in FIGS. 3 and 9, the first lens barrel 3 includes an object-side step portion 101 at an end portion of an inner peripheral surface on the object side X1, and an image-side step portion 102 at an end portion of the inner peripheral surface on the image side X2. Furthermore, the first lens barrel 3 includes an intermediate step portion 103 between the object-side step portion 101 and the image-side step portion 102 of the inner peripheral surface in the optical axis direction X.

The object-side step portion 101 has a support surface 105 that faces the object side X1, an annular wall surface 106 that extends from an inner peripheral end of the support surface 105 to the image side X2 and faces inward in the radial direction, and a peripheral wall surface 107 that extends from an outer peripheral end of the support surface 105 to the object side X1.

In the first lens barrel 3, a portion of the object-side step portion 101 on the object side X1 is a housing portion 108 that houses an outer peripheral edge portion of the lens L1. The second lens barrel 4 is disposed on the inner peripheral side of the annular wall surface 106.

The housing portion 108 has the peripheral wall surface 107, the support surface 105, and a caulking portion 109. As illustrated in FIG. 2, the peripheral wall surface 107 faces the lens L1 from outside in the radial direction. The support surface 105 faces the end surface 11 of the lens L1 from the image side X2. The caulking portion 109 is in contact with the lens L1 from the object side X1 at a position overlapping with the support surface 105 as viewed from the optical axis direction X along the optical axis L of the lens L1.

The caulking portion 109 is a plastically deformed portion formed, for example, by thermal caulking in which an end portion of the first lens barrel 3 on the object side X1 is bent toward the inner peripheral side. Here, the outer peripheral edge portion of the lens L1 is disposed between the support surface 105 and the caulking portion 109. The first O-ring 7 is disposed between the end surface of the lens L1 on the image side X2 and the support surface 105, and is compressed in the optical axis direction X.

As illustrated in FIG. 3, the annular wall surface 106 has, at multiple positions in the circumferential direction, object-side protrusions 110 that protrude inward in the radial direction. In this example, the object-side protrusions 110 are provided at equal angular intervals at three positions in the circumferential direction. Each of the object-side protrusions 110 is an object-side positioning portion that positions the second lens barrel 4 in the radial direction.

As illustrated in FIGS. 3 and 9, the image-side step portion 102 has an annular image-side end surface 112 that faces the object side X1, and an annular image-side inner wall surface 113 that extends from an inner peripheral end of the image-side end surface 112 to the image side X2 and reaches an end of the first lens barrel 3 on the image side X2. The image-side end surface 112 has multiple ribs 114 that protrude to the object side X1 and extend in an arc shape in the circumferential direction. In this example, the ribs 114 are provided at equal angular intervals at three positions in the circumferential direction. Each of the ribs 114 is an image-side positioning portion that positions the second lens barrel 4 in the optical axis direction X.

The intermediate step portion 103 has an annular step portion end surface 116 that faces the object side X1, and an annular step portion wall surface 117 that extends from an inner peripheral end of the step portion end surface 116 to the image side X2. In this example, the intermediate step portion 103 has, at multiple positions in the circumferential direction, notched grooves 118 that extend in the optical axis direction X and divide the step portion end surface 116 and the step portion wall surface 117 in the circumferential direction. In this example, the notched grooves 118 are provided at equal angular intervals at three positions in the circumferential direction. Thus, the intermediate step portion 103 is divided into three portions in the circumferential direction by the notched grooves 118. A bottom surface (surface facing the inner peripheral side) of each of the notched grooves 118 is a tapered surface, and the inner diameter of the bottom surface decreases toward the image side X2. As illustrated in FIG. 2, the bottom surface of each of the notched grooves 118 is continuous with an inner peripheral surface portion that extends from an outer peripheral end of the image-side end surface 112 of the image-side step portion 102 to the object side X1 on the inner peripheral surface of the first lens barrel 3.

Here, as illustrated in FIG. 3, the notched grooves 118 are provided at the same angular positions as the ribs 114 of the image-side step portion 102. Furthermore, the notched grooves 118 are provided at the same angular positions as the object-side protrusions 110 of the object-side step portion 101. When the first lens barrel 3 is connected to the second lens barrel 4 disposed on the inner peripheral side of the first lens barrel 3, an adhesive is applied to the step portion end surface 116 of each the three divided portions of the intermediate step portion 103. Thus, a lens barrel connecting adhesive layer 51 is provided on the step portion end surface 116 and the step portion wall surface 117.

### Second Lens Barrel and Lenses L2 to L6

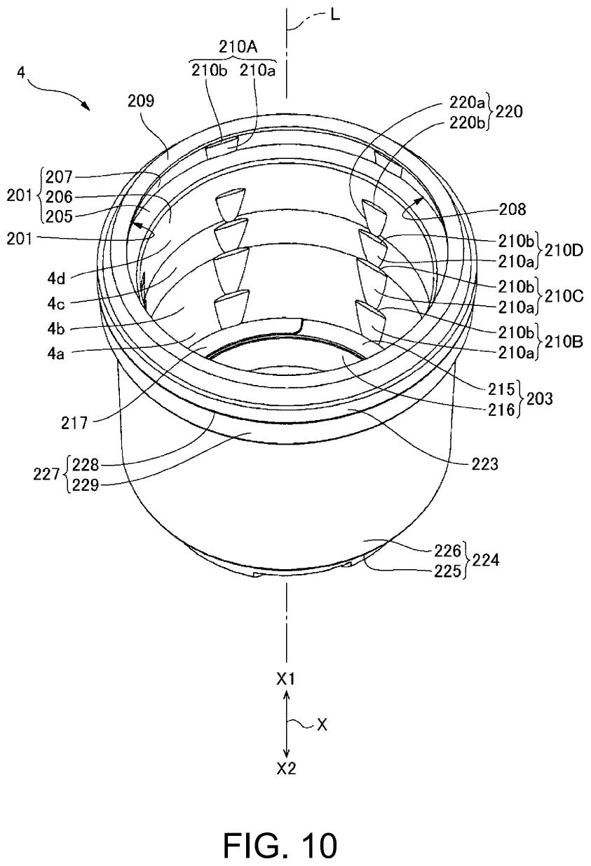

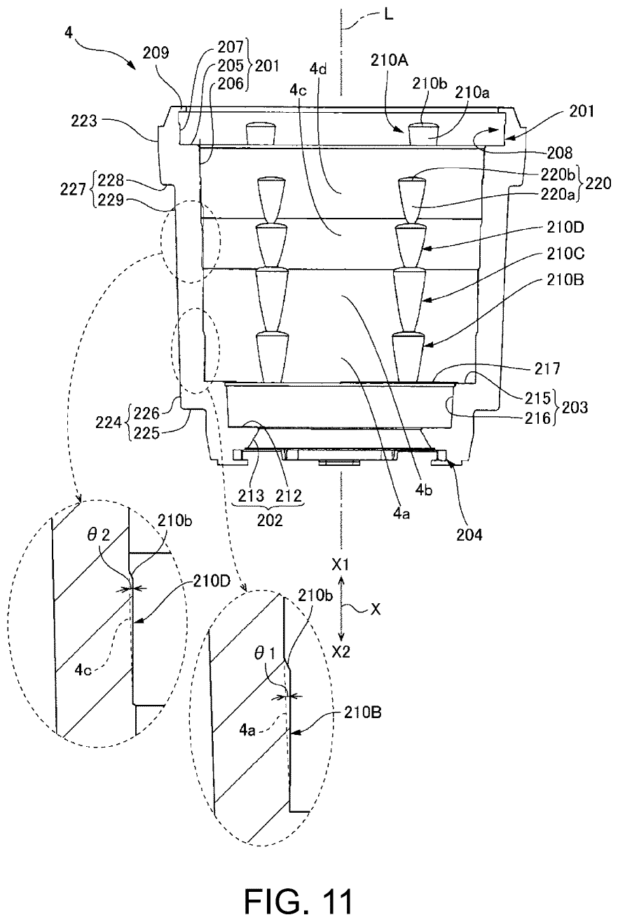

FIG. 10 is a perspective view of the second lens barrel 4 as viewed from the object side. FIG. 11 is a cross-sectional view of the second lens barrel 4. Each of the regions surrounded by a dashed line in FIG. 11 is a partially enlarged view of a portion around a fitting protrusion 210. The second lens barrel 4 houses the lens L2, the lens L3, the lens L4, the lens L5, the holder 28, and the lens L6 on the inner peripheral side.

As illustrated in FIGS. 10 and 11, the second lens barrel 4 includes an object-side step portion 201 at an end portion of an inner peripheral surface on the object side X1. The second lens barrel 4 includes an image-side step portion 202 at an end portion of the inner peripheral surface on the image side X2. Furthermore, the second lens barrel 4 includes a positioning step portion 203 at a position that is located between the object-side step portion 201 and the image-side step portion 202 and is closer to the image-side step portion 202 than the object-side step portion 201. Furthermore, the second lens barrel 4 includes, at an end portion of the second lens barrel 4 on the object side X1, a cover holding portion 204 that holds the cover 10.

As illustrated in FIG. 11, the object-side step portion 201 has a seat surface 205 that faces the object side X1, an annular wall surface 206 that extends from an inner peripheral end of the seat surface 205 to the image side X2, and a peripheral wall surface 207 that extends from an outer peripheral end of the seat surface 205 to the object side X1. The annular wall surface 206 is a tapered surface whose inner diameter increases toward the object side X1. In the second lens barrel 4, a portion of the object-side step portion 201 on the object side X1 is a housing portion 208 that houses an outer peripheral edge portion of the lens L2.

The housing portion 208 has the peripheral wall surface 207, the seat surface 205, and a caulking portion 209. As illustrated in FIG. 2, the peripheral wall surface 207 faces the lens L2 from outside in the radial direction. The seat surface 205 faces, from the image side X2, an end surface of the flange portion 14 of the lens L2 on the image side X2. The caulking portion 209 is in contact with the lens L2 from the object side X1 at a position overlapping with the seat surface 205 as viewed from the optical axis direction X.

As illustrated in FIG. 10, the peripheral wall surface 207 is a tapered surface inclined to the outer peripheral side from the seat surface 205 toward the object side X1. The peripheral wall surface 207 has, at multiple positions apart from each other in the circumferential direction, fitting protrusions 210A to be pressure bonded to the lens L2. In this example, the fitting protrusions 210A are provided at equal angular intervals at six positions in the circumferential direction.

Each of the fitting protrusions 210A has, at an inner peripheral end, a pressure bonding surface 210a that is parallel to the optical axis L. Furthermore, each of the fitting protrusions 210A has a curved surface 210b that is curved to the outer peripheral side from the pressure bonding surface 210a toward the object side X1. The pressure bonding surfaces 210a of the fitting protrusions 210A are pressure bonded from outside in the radial direction to the lens L2 housed in the housing portion 208 to position the lens L2 in the radial direction.

As illustrated in FIG. 11, the image-side step portion 202 has an annular image-side end surface 212 that faces the object side X1, and an image-side inner wall surface 213 that extends from an inner peripheral end of the image-side end surface 212 to the image side X2. The image-side inner wall surface 213 is a tapered surface inclined to the outer peripheral side toward the image side X2. As illustrated in FIG. 2, the image-side end surface 212 faces the image-side lens L62 of the lens L6 with a gap in the optical axis direction X. The cover holding portion 204 is provided on the outer peripheral side of the image-side inner wall surface 213.

As illustrated in FIGS. 10 and 11, the positioning step portion 203 has an annular positioning surface 215 that faces the object side X1, and a positioning step portion peripheral wall surface 216 that extends from an inner peripheral end of the positioning surface 215 to the image side X2. The positioning surface 215 has multiple positioning ribs 217 that protrude to the object side X1 and extend in an arc shape in the circumferential direction. In this example, the positioning ribs 217 are provided at equal angular intervals at three positions in the circumferential direction. A lower end of the positioning step portion peripheral wall surface 216 reaches the image-side end surface 212. The positioning step portion peripheral wall surface 216 faces the image-side lens L62 of the lens L6 with a gap in the radial direction.

As illustrated in FIG. 2, the positioning ribs 217 are positioning portions that are in contact with the flange portion 36 of the object-side lens L61 of the lens L6 from the image side X2 to position the lens L6 in the optical axis direction X. Here, the flange portion 36 of the object-side lens L61 of the lens L6 is in contact with the positioning portions to position, in the optical axis direction X, the lens L3 and the laminated body 44 composed of the lens L4, the holder 28, the lens L5, and the lens L6.

More specifically, the holder 28 is supported by the lens L6 from the image side X2 to be positioned at a predetermined position in the optical axis direction X. The lens L4 is supported by the holder 28 from the image side X2 to be positioned at a predetermined position in the optical axis direction X. The lens L5 is in contact with the lens L6 to be positioned in the optical axis direction X and the radial direction. The lens L3 is fitted to the lens L4 to be positioned in the optical axis direction X and the radial direction. Here, when the lens L5 is positioned in the optical axis direction X and the radial direction, the lens L5 is not in contact with the holder 28. When the lens L3 and the lens L4 are positioned in the optical axis direction X and the radial direction, the lens L3 is not in contact with the second lens barrel 4. The lens L3, the lens L4, the holder 28, and the lens L5 are located between the object-side step portion 201 and the positioning step portion 203 in the optical axis direction X.

As illustrated in FIGS. 10 and 11, on the inner peripheral surface of the second lens barrel 4, an inner peripheral surface portion 4a that is located outside the object-side lens L61 of the lens L6 in the radial direction is a tapered surface inclined to the outer peripheral side toward the object side X1. The inner peripheral surface portion 4a has, at multiple positions apart from each other in the circumferential direction, fitting protrusions 210B to be pressure bonded to the lens L6. The fitting protrusions 210B are provided at equal angular intervals at six positions in the circumferential direction.

Each of the fitting protrusions 210B has, at an inner peripheral end, a pressure bonding surface 210a that is parallel to the optical axis L. Furthermore, each of the fitting protrusions 210B has a curved surface 210b that is curved to the outer peripheral side from the pressure bonding surface 210a toward the object side X1. The pressure bonding surfaces 210a of the fitting protrusions 210B are pressure bonded from outside in the radial direction to the lens L6 housed in the second lens barrel 4 to position the lens L6 in the radial direction.

Furthermore, on the inner peripheral surface of the second lens barrel 4, an inner peripheral surface portion 4b that is located outside the holder 28 in the radial direction is a tapered surface inclined to the outer peripheral side toward the object side X1. The inner peripheral surface portion 4b has, at multiple positions apart from each other in the circumferential direction, fitting protrusions 210C to be pressure bonded to the lens L6. The fitting protrusions 210C are provided at equal angular intervals at six positions in the circumferential direction. Each of the fitting protrusions 210C has, at an inner peripheral end, a pressure bonding surface 210a that is parallel to the optical axis L. Furthermore, each of the fitting protrusions 210C has a curved surface 210b that is curved to the outer peripheral side from the pressure bonding surface 210a toward the object side X1. The pressure bonding surfaces 210a of the fitting protrusions 210C are pressure bonded from outside in the radial direction to the holder 28 housed in the second lens barrel 4 to position the holder 28 in the radial direction.

Furthermore, on the inner peripheral surface of the second lens barrel 4, an inner peripheral surface portion 4c that is located outside the lens L4 in the radial direction is a tapered surface inclined to the outer peripheral side toward the object side X1. The inner peripheral surface portion 4c has, at multiple positions apart from each other in the circumferential direction, fitting protrusions 210D to be pressure bonded to the lens L4. The fitting protrusions 210D are provided at equal angular intervals at six positions in the circumferential direction. Each of the fitting protrusions 210D has, at an inner peripheral end, a pressure bonding surface 210a that is parallel to the optical axis L. Furthermore, each of the fitting protrusions 210D has a curved surface 210b that is curved to the outer peripheral side from the pressure bonding surface 210a toward the object side X1.

The pressure bonding surfaces 210a of the fitting protrusions 210D are pressure bonded from outside in the radial direction to the lens L4 housed in the second lens barrel 4 to position the lens L4 in the radial direction.

Furthermore, on the inner peripheral surface of the second lens barrel 4, an inner peripheral surface portion 4d that is located outside the lens L3 in the radial direction is a tapered surface inclined to the outer peripheral side toward the object side X1. The inner peripheral surface portion 4d located outside the lens L3 in the radial direction is continuous, without a step, with a portion of the annular wall surface 206 of the object-side step portion 201 on the image side X2. The inner peripheral surface portion 4d has, at multiple positions apart from each other in the circumferential direction, guide protrusions 220 that guide the lens L3 in the optical axis direction X. The guide protrusions 220 are provided at equal angular intervals at six positions in the circumferential direction. Each of the guide protrusions 220 has, at an inner peripheral end, a guide surface 220a that is parallel to the optical axis L. Furthermore, each of the guide protrusions 220 has a curved surface 220b that is curved to the outer peripheral side from the pressure bonding surface 210a toward the object side X1. When the lens L3 is fitted to the lens L4, the guide protrusions 220 are located outside the lens L3 in the radial direction; however, the guide protrusions 220 are not in contact with the lens L3.

The guide surface 220a of each of the guide protrusions 220 faces the lens L3 with a slight gap in the radial direction.

Here, the second O-ring 8 is disposed at a position that is located on the object side X1 of the guide protrusions 220 and is inside the annular wall surface 206 of the object-side step portion 201 in the radial direction. As illustrated in FIG. 2, the second O-ring 8 is compressed in the optical axis direction X between the lens L2 housed in the housing portion 208 and the lens L3.

As illustrated in FIG. 11, a first inclination angle θ1 at which the tapered inner peripheral surface portion 4a located outside the lens L6 in the radial direction is inclined with respect to the optical axis L is different from a second inclination angle θ2 at which the tapered inner peripheral surface portion 4c located outside the lens L4 in the radial direction is inclined with respect to the optical axis L. That is, the inclination of each of the inner peripheral surface portions 4a to 4d located outside one of the lenses and the holder 28 in the radial direction may be appropriately set according to the outer diameter of the one of the lenses and the holder 28. On the inner peripheral surface of the second lens barrel 4, the inner peripheral surface portion 4a located between the object-side step portion 201 and the positioning step portion 203 is inclined as a whole to the outer peripheral side toward the object side X1.

Furthermore, the second lens barrel 4 has an annular outer peripheral surface side positioning surface 223 at an end portion of an outer peripheral surface on the object side X1. The outer peripheral surface side positioning surface 223 is located outside the housing portion 208 in the radial direction. The outer peripheral surface side positioning surface 223 faces outward in the radial direction. Furthermore, the second lens barrel 4 includes an outer peripheral surface image-side step portion 224 at the image-side X2 portion of the outer peripheral surface. The outer peripheral surface image-side step portion 224 has an annular surface 225 that faces the image side X2, and an outer peripheral surface portion 226 that extends from an outer peripheral end of the annular surface 225 to the object side X1. Furthermore, the second lens barrel 4 includes an outer peripheral surface intermediate step portion 227 between the end portion of the outer peripheral surface on the object side X1 (outer peripheral surface side positioning surface 223) and the outer peripheral surface image-side step portion 224. The outer peripheral surface intermediate step portion 227 has an annular surface 228 that faces the image side X2, and an outer peripheral surface portion 229 that extends from an inner peripheral end of the annular surface 228 to the image side X2.

### Assembly of Lens Unit

FIG. 12 is an explanatory diagram of a method of aligning the lens L6 with the lens L5. When the lens unit 1 is assembled, first, a second unit assembling operation is performed to house the lenses L2 to L6 in the second lens barrel 4. Next, a lens barrel fixing operation is performed to cause the second lens barrel 4 to be held and fixed to the first lens barrel 3. Then, a first unit assembling operation is performed to house the lens L1 in the first lens barrel 3.

In the second unit assembling operation, as illustrated in FIG. 12, first, the lens L5 is stacked on the lens L6 outside the second lens barrel 4, and the contact portion 26 of the lens L5 is brought into line contact with the contacted portion 37 of the lens L6 (step ST1). Then, the lens L6 is vibrated until the annular contact line M on which the contact portion 26 is in contact with the contacted portion 37 is located on the virtual vertical plane S whose axis coincides with the optical axis L and that is perpendicular to the optical axis L (step ST2). Here, when the annular contact line M on which the contact portion 26 is in contact with the contacted portion 37 is located on the virtual vertical plane S whose axis coincides with the optical axis L and that is perpendicular to the optical axis L, the lens L5 is aligned with the lens L6. That is, the lens L5 is positioned relative to the lens L6 in the optical axis direction X and the radial direction.

After completion of the alignment, an adhesive is applied to a portion between the lens L1 and the lens L2 on the outer peripheral side of the contact line M. Furthermore, the adhesive is cured. Thus, the lens L6 and the lens L5 are fixed by an adhesive layer 52 that is formed between the lens L6 and the lens L5 (step ST3).

Next, the lens L5 and the lens L6 fixed to each other are housed in the second lens barrel 4 from the object side X1. At this time, as can be seen from FIG. 10, the lens L6 is press fitted to the inner peripheral side of the fitting protrusions 210B provided closest to the image side X2 on the inner peripheral surface of the second lens barrel 4. Thus, the pressure bonding surfaces 210a of the respective fitting protrusions 210B are pressure bonded to the lens L6 (object-side lens L61) from outside in the radial direction to position the lens L6 in the radial direction. Furthermore, the flange portion 36 of the object-side lens L61 of the lens L6 is brought into contact with the positioning ribs 217 of the positioning step portion 203 of the second lens barrel 4. Thus, the lens L6 is positioned in the optical axis direction X. When the lens L6 is positioned in the optical axis direction X and the radial direction, the lens L5 fixed to the lens L6 is also positioned in the optical axis direction X and the radial direction.

Then, the holder 28 is housed in the second lens barrel 4 from the object side X1. At this time, the holder 28 is press fitted to the inner peripheral side of the fitting protrusions 210C second closest to the image side X2 on the inner peripheral surface of the second lens barrel 4. Thus, the pressure bonding surfaces 210a of the respective fitting protrusions 210C are pressure bonded to the holder 28 from outside in the radial direction to position the holder 28 in the radial direction. Furthermore, the holder 28 is brought into contact with the lens L6 from the object side X1 to be supported by the lens L6 from the image side X2 and positioned in the optical axis direction X. Here, the gap 28a is formed between the inner peripheral surface of the holder 28 and the lens L5. Thus, an adhesive is dropped into the gap 28a to fix the holder 28 and the lens L5 via an adhesive layer 53 (see FIG. 8). In this example, the adhesive is applied to the notched portions 31 provided in the outer peripheral portion 30 of the holder 28. Thus, the adhesive passes through the central portion 29 and reaches the gap 28a between the holder 28 and the inner peripheral surface of the holder 28 and the lens L5.

Then, the lens L4 is housed in the second lens barrel 4 from the object side X1. At this time, the lens L4 is press fitted to the inner peripheral side of the fitting protrusions 210D third closest to the image side X2 on the inner peripheral surface of the second lens barrel 4. Thus, the pressure bonding surfaces 210a of the respective fitting protrusions 210D are pressure bonded to the lens L4 from outside in the radial direction to position the lens L4 in the radial direction. Furthermore, the lens L4 is brought into contact with the holder 28 from the object side X1 to be supported by the holder 28 from the image side X2 and positioned in the optical axis direction X. Here, the laminated body 44 composed of the lens L4, the holder 28, the lens L5, and the lens L6 is formed inside the second lens barrel 4.

Next, the lens L3 is housed in the second lens barrel 4 from the object side X1. At this time, the lens L3 is inserted into the inner peripheral side of the guide protrusions 220. Thus, the lens L3 is guided in a predetermined orientation in the optical axis direction X, and the fitting portion 18 of the lens L3 is inserted into the fitted portion 22 of the lens L4. Furthermore, the lens L3 guided by the guide protrusions 220 is pressed into the lens L4 from the object side X1. Thus, the fitting portion 18 of the lens L3 is fitted to the fitted portion 22 of the lens L4.

While the fitting portion 18 of the lens L3 is fitted to the fitted portion 22 of the lens L4, the fitting portion tapered surface 18a of the fitting portion 18 is in surface contact with the fitted portion tapered surface 22a of the fitted portion 22. Thus, the lens L3 is positioned in the radial direction with respect to the lens L4. Furthermore, while the fitting portion 18 of the lens L3 is fitted to the fitted portion 22 of the lens L4, the outer peripheral side portion of the fitting portion 18 in the flange portion 17 of the lens L3 is in contact in the optical axis direction X with the outer peripheral side portion of the fitted portion 22 in the flange portion 21 of the lens L4. Thus, the lens L3 is positioned in the optical axis direction X.

Then, the second O-ring 8 is placed on the flange portion 17 of the lens L3 from the object side X1. Next, the light shielding sheet 9 is supported by the support surface 105. Furthermore, the lens L2 is supported by the support surface 105 via the light shielding sheet 9. At this time, the lens L2 is press fitted to the inner peripheral side of the fitting protrusions 210A located closest to the object side X1 on the inner peripheral surface of the second lens barrel 4. Thus, the pressure bonding surfaces 210a of the respective fitting protrusions 210A are pressure bonded to the lens L2 from outside in the radial direction to position the lens L2 in the radial direction. Furthermore, the lens L2 is brought into contact with the light shielding sheet 9 from the object side X1 to be positioned in the optical axis direction X.

Then, the caulking portion 209 bent to the inner peripheral side is formed at the end portion of the second lens barrel 4 on the object side X1, and the caulking portion 209 is brought into contact with the outer peripheral edge portion of the lens L2 from the object side X1. In this example, the caulking portion 209 is formed by thermal caulking.

Thus, the second unit assembling operation is completed. After completion of the second unit assembling operation, the second O-ring 8 is compressed in the optical axis direction X between the lens L2 and the lens L3.

Next, the lens barrel fixing operation is performed to cause the second unit 60 to be held by the first unit 50. In the lens barrel fixing operation, as can be seen from FIGS. 3 and 9, an adhesive is applied to the step portion end surface 116 of each of the three portions of the intermediate step portion 103 provided on the inner peripheral surface of the first lens barrel 3. Then, the second unit 60 is inserted into the inner peripheral side of the first lens barrel 3 from the object side X1. Then, as can be seen from FIGS. 11 and 9, the annular surface 225 of the outer peripheral surface image-side step portion 224 provided in the image-side portion of the outer peripheral surface of the second lens barrel 4 is brought into contact with the ribs 114 (image-side positioning portions) of the image-side step portion 102 provided on the inner peripheral surface of the first lens barrel 3. Furthermore, the annular outer peripheral surface side positioning surface 223 provided at the end portion of the second lens barrel 4 on the object side X1 is brought into contact with the object-side protrusions 110 provided on the annular wall surface 106 of the object-side step portion 101 of the first lens barrel 3.

Here, the inner peripheral surface of the first lens barrel 3 faces the outer peripheral surface of the second lens barrel 4 with a gap, except for a contact portion at which the image-side step portion 202 of the second lens barrel 4 is in contact with the image-side step portion 102 of the first lens barrel 3 and a contact portion at which the annular positioning surface 215 of the second lens barrel 4 is in contact with the object-side step portion 101 of the first lens barrel 3. Thus, the second lens barrel 4 is positioned in the optical axis direction X and the radial direction with respect to the first lens barrel 3 by the two contact portions.

When the second unit 60 is inserted into the inner peripheral side of the first lens barrel 3, the intermediate step portion 103 on the inner peripheral surface of the first lens barrel 3 faces, with a gap, the outer peripheral surface intermediate step portion 227 on the outer peripheral surface of the second lens barrel 4. That is, the step portion end surface 116 of the intermediate step portion 103 of the first lens barrel 3 faces, with a gap in the optical axis direction X, the annular surface 228 of the outer peripheral surface intermediate step portion 227 of the second lens barrel 4. Furthermore, the step portion wall surface 117 of the intermediate step portion 103 of the first lens barrel 3 faces, with a gap in the radial direction, the outer peripheral surface portion 229 of the outer peripheral surface intermediate step portion 227 of the second lens barrel 4. Here, the adhesive applied to the step portion end surface 116 of the intermediate step portion 103 of the first lens barrel 3 is spread to the step portion wall surface 117 when the second unit 60 is inserted into the inner peripheral side of the first lens barrel 3. Thus, as illustrated in FIG. 2, the lens barrel connecting adhesive layer 51 is interposed between the step portion end surface 116 of the intermediate step portion 103 of the first lens barrel 3 and the annular surface 228 of the outer peripheral surface intermediate step portion 227 of the second lens barrel 4. Furthermore, the lens barrel connecting adhesive layer 51 is interposed between the step portion wall surface 117 of the intermediate step portion 103 of the first lens barrel 3 and the outer peripheral surface portion 229 of the outer peripheral surface intermediate step portion 227 of the second lens barrel 4. Each of the intermediate step portion 103 of the first lens barrel 3 and the outer peripheral surface intermediate step portion 227 of the second lens barrel 4 is an adhesive fixing portion that connects the first lens barrel 3 to the second lens barrel 4 via the lens barrel connecting adhesive layer 51.

Next, in the first unit assembling operation, the first O-ring 7 is placed on the support surface 105 of the first lens barrel 3. Then, the lens L1 is supported by the support surface 105 via the first O-ring 7. Then, the caulking portion 109 bent to the inner peripheral side is formed at the end portion of the first lens barrel 3 on the object side X1. Thus, the caulking portion 109 is brought into contact with the outer peripheral edge portion of the lens L1 from the object side X1. In this example, the caulking portion 109 is formed by thermal caulking. When the caulking portion 109 is formed, the first O-ring 7 is compressed in the optical axis direction X between the end surface of the lens L1 on the image side X2 and the support surface 105 of the first lens barrel 3.

Here, when the lens L1 is held by the first lens barrel 3, the annular protruding portion 15 provided in the flange portion 14 of the lens L2 held by the second lens barrel 4 is in surface contact with the end surface 11 of the lens L1 on the image side X2.

As illustrated in FIG. 2, an air passage 70 is formed between the first lens barrel 3 and the second lens barrel 4. The air passage 70 passes through a gap between an end 3a of the first lens barrel 3 on the image side X2 and an end 4e of the second lens barrel 4 on the image side X2, a gap between the ribs 114 adjacent to each other in the circumferential direction in the image-side step portion 102 of the first lens barrel 3, the notched grooves 118 provided in the intermediate step portion 103 of the first lens barrel 3, and a gap between the object-side protrusions 110 adjacent to each other in the circumferential direction on the annular wall surface 106 of the object-side step portion 101 of the first lens barrel 3. The air passage 70 communicates with a space that is located between the lens L1 and the support surface 105 and is closer to the inner peripheral side than the first O-ring 7.

### Operation Effects

The lens unit 1 according to this example includes the lens L1 (first lens), the lens L2 (second lens) that is disposed on the image side X2 of the lens L1, the first lens barrel 3 that houses the first lens, and the second lens barrel 4 that houses the lens L2 and is held on the inner peripheral side of the first lens barrel 3. The second lens barrel 4 includes, in the image-side portion of the outer peripheral surface, the outer peripheral surface image-side step portion 224 (first step portion) having the annular surface 225 (first annular surface) that faces the image side X2 and the outer peripheral surface portion 226 (first outer peripheral surface portion) that extends from the outer peripheral end of the annular surface 225 to the object side X1. The first lens barrel 3 has the ribs 114 (first positioning portions) of the image-side step portion 102 that are in contact with the annular surface 225 from the image side X2 to position the second lens barrel 4 in the optical axis direction X, and the object-side protrusions 110 (second positioning portions) that are in contact with the end portion of the second lens barrel 4 on the object side X1 from outside in the radial direction to position the second lens barrel 4 in the radial direction. The adhesive fixing portions (the intermediate step portion 103 of the first lens barrel 3 and the outer peripheral surface intermediate step portion 227 of the second lens barrel 4) that connect the first lens barrel 3 to the second lens barrel 4 via the lens barrel connecting adhesive layer 51 (adhesive layer) are provided between the ribs 114 of the image-side step portion 102 and the object-side protrusions 110 in the optical axis direction X.

According to this example, the second lens barrel 4 that houses the lens L2 includes, in the image-side portion of the outer peripheral surface, the outer peripheral surface image-side step portion 224 having the annular surface 225 facing the image side X2. On the other hand, the first lens barrel 3 that houses the lens L1 has the ribs 114 of the image-side step portion 102 that are in contact with the annular surface 225 from the image side X2 to position the second lens barrel 4 in the optical axis direction X, and the object-side protrusions 110 that are in contact with the end portion of the second lens barrel 4 on the object side X1 from outside in the radial direction to position the second lens barrel 4 in the radial direction. Thus, when the second lens barrel 4 is held by the first lens barrel 3, the second lens barrel 4 is positioned in the optical axis direction X at the end portion of the second lens barrel 4 on the image side X2 in the optical axis direction X, and is positioned in the radial direction at the end portion of the second lens barrel 4 on the object side X1 in the optical axis direction X. Both end portions of the second lens barrel 4 in the optical axis direction X are positioned by the ribs 114 of the image-side step portion 102 and the object-side protrusions 110 provided in the first lens barrel 3; thus, it is possible to prevent or suppress the occurrence of tilting of the second lens barrel 4. Furthermore, the object-side protrusions 110 that position the second lens barrel 4 in the radial direction are located on the object side X1; thus, the optical axis L of the lens L1 held by the first lens barrel 3 is more likely to coincide with the optical axis L of the lens L2 held by the second lens barrel 4.

Furthermore, the adhesive fixing portions (the intermediate step portion 103 of the first lens barrel 3 and the outer peripheral surface intermediate step portion 227 of the second lens barrel 4) that connect the first lens barrel 3 to the second lens barrel 4 via the lens barrel connecting adhesive layer 51 are provided between the ribs 114 of the image-side step portion 102 and the object-side protrusions 110 in the optical axis direction X. Thus, after completion of the positioning of the second lens barrel 4 in the optical axis direction X and the radial direction by the ribs 114 of the image-side step portion 102 and the object-side protrusions 110, it is possible to fix the first lens barrel 3 and the second lens barrel 4 by the adhesive.

In this example, the lens unit 1 includes the laminated body 44 (laminated body in which optical members including multiple lenses are laminated) on the image side X2 of the lens L2. The laminated body 44 is housed in the second lens barrel 4 on the image side X2 of the lens L2. Here, when the laminated body 44 is housed in the second lens barrel 4, the second lens barrel 4 is more likely to be long in the optical axis direction X. Thus, if tilting of the second lens barrel 4 occurs, the optical axis is inclined between the lens L1 and the laminated body 44, and deterioration in the optical performance is more likely to occur. However, both end portions of the second lens barrel 4 in the optical axis direction X are positioned by the ribs 114 of the image-side step portion 102 and the object-side protrusions 110 provided in the first lens barrel 3; thus, it is possible to prevent or suppress the occurrence of tilting of the second lens barrel 4. This makes it possible to suppress deterioration in the optical performance.

In this example, the first lens barrel 3 has, on the inner peripheral surface, the annular image-side end surface 112 (first facing surface portion) that faces the annular surface 225 in the optical axis direction X and the annular wall surface 106 (second facing surface portion) that faces the end portion of the second lens barrel 4 on the object side X1 in the radial direction. The image-side end surface 112 has the ribs 114 (first protrusions) protruding in the optical axis direction X at multiple positions in the circumferential direction, and the second facing surface portion has the object-side protrusions 110 (second protrusions) protruding to the inner peripheral side at multiple positions in the circumferential direction. Each of the ribs 114 of the image-side step portion 102 is the image-side positioning portion (first positioning portion). Each of the object-side protrusions 110 is the object-side positioning portion (second positioning portion). Thus, it is possible to accurately position the first lens barrel 3 and the second lens barrel 4 in the optical axis direction X as compared with a case where the first lens barrel 3 and the second lens barrel 4 are positioned in the optical axis direction X by bringing the annular surface 225 of the second lens barrel 4 into surface contact with the annular image-side end surface 112 of the first lens barrel 3. Furthermore, it is possible to accurately position the first lens barrel 3 and the second lens barrel 4 in the radial direction as compared with a case where the first lens barrel 3 and the second lens barrel 4 are positioned in the radial direction by bringing the end portion of the second lens barrel 4 on the object side X1 into surface contact with the annular wall surface 106 of the first lens barrel 3.

In this example, the second lens barrel 4 includes, between the end portion of the outer peripheral surface on the object side X1 and the outer peripheral surface image-side step portion 224, the outer peripheral surface intermediate step portion 227 (second step portion) having the annular surface 228 (second annular surface) that faces the image side X2 and the outer peripheral surface portion 229 (second outer peripheral surface portion) that extends from the inner peripheral end of the annular surface 228 to the image side X2. The first lens barrel 3 includes, on the inner peripheral surface, the intermediate step portion 103 (first lens barrel-side step portion) having the annular step portion end surface 116 (first facing surface) that faces the annular surface 228 and the step portion wall surface 117 (step portion wall surface) that extends from the inner peripheral end of the step portion end surface 116 to the image side X2. The lens barrel connecting adhesive layer 51 is interposed between the annular surface 228 and the step portion end surface 116 and between the outer peripheral surface portion 229 and the step portion wall surface 117. Thus, it is possible to form the lens barrel connecting adhesive layer 51 by applying an adhesive to the step portion end surface 116 of the first lens barrel 3 from the object side X1.

In this example, the intermediate step portion 103 has, at multiple positions in the circumferential direction, the notched grooves 118 that extend in the optical axis direction X and divide the step portion end surface 116 and the step portion wall surface 117 in the circumferential direction. Thus, no adhesive is applied to the portions of the intermediate step portion 103 in which the notched grooves 118 are provided. Therefore, the first lens barrel 3 and the second lens barrel 4 are connected via the lens barrel connecting adhesive layer 51, except for the portions in which the notched grooves 118 are formed.

In this example, the lens unit 1 includes the first O-ring 7 (O-ring) that is provided on the outer peripheral side of the second lens barrel 4 and is in contact with the lens L1 from the image side X2. The first lens barrel 3 has the annular caulking portion 109 that is bent from the tip portion of the first lens barrel 3 on the object side X1 to the inner peripheral side and is in contact with the outer peripheral end portion of the lens L1 from the object side X1, and the annular support surface 105 that faces the object side X1 at a position overlapping with the caulking portion 109 as viewed from the optical axis direction X. The outer peripheral end portion of the lens L1 is located between the caulking portion 109 and the support surface 105, and the first O-ring 7 is compressed in the optical axis direction X between the outer peripheral end portion of the lens L1 and the support surface 105. The annular wall surface 106 extends from the inner peripheral end of the support surface 105 to the image side X2, and the air passage 70 is formed between the first lens barrel 3 and the second lens barrel 4. The air passage 70 passes through the gap between the end of the first lens barrel 3 on the image side X2 and the end of the second lens barrel 4 on the image side X2, the gap between the ribs 114 adjacent to each other in the circumferential direction, the notched grooves 118, and the gap between the object-side protrusions 110 adjacent to each other in the circumferential direction. The air passage 70 communicates with the space that is located between the lens L1 and the support surface 105 and is closer to the inner peripheral side than the first O-ring 7. Thus, after completion of the assembly of the lens unit 1, it is possible to blow air into a portion between the end of the first lens barrel 3 on the image side X2 and the end of the second lens barrel 4 on the image side X2 to check whether the portion between the outer peripheral end portion of the lens L1 and the support surface 105 is liquid tightly sealed by the first O-ring 7.

### Modifications

In the above example, the ribs 114 protruding in the optical axis direction X at multiple positions in the circumferential direction are provided on the image-side end surface 112 of the first lens barrel 3; however, ribs for positioning may be provided on the annular surface 225 of the outer peripheral surface image-side step portion 224 of the second lens barrel 4 facing the image-side end surface 112.

In the above example, the object-side protrusions 110 are provided on the annular wall surface 106 of the first lens barrel 3; however, protrusions for positioning may be provided on the annular outer peripheral surface side positioning surface 223 provided at the end portion of the second lens barrel 4 on the object side X1.

1. A lens unit comprising:
a first lens;
a second lens that is disposed on an image side of the first lens;
a first lens barrel that houses the first lens; and
a second lens barrel that houses the second lens and is held on an inner peripheral side of the first lens barrel, wherein
the second lens barrel includes, in an image-side portion of an outer peripheral surface, a first step portion having a first annular surface that faces the image side and a first outer peripheral surface portion that extends from an outer peripheral end of the first annular surface to an object side,
when a direction along an optical axis of the first lens is defined as an optical axis direction, the first lens barrel has a first positioning portion that is in contact with the first annular surface from the image side to position the second lens barrel in the optical axis direction, and a second positioning portion that is in contact with an end portion of the second lens barrel on the object side from outside in a radial direction to position the second lens barrel in the radial direction, and
an adhesive fixing portion that connects the first lens barrel to the second lens barrel via an adhesive layer is provided between the first positioning portion and the second positioning portion in the optical axis direction.

2. The lens unit according to claim 1, comprising
a laminated body in which optical members including a plurality of lenses are laminated, wherein
the laminated body is housed in the second lens barrel on the image side of the second lens.

3. The lens unit according to claim 1, wherein
the first lens barrel has, on an inner peripheral surface, an annular first facing surface portion that faces the first annular surface in the optical axis direction and an annular second facing surface portion that faces the end portion of the second lens barrel on the object side in the radial direction,
first protrusions that protrude in the optical axis direction at a plurality of positions in a circumferential direction are provided in the first facing surface portion,
second protrusions that protrude to the inner peripheral side at a plurality of positions in the circumferential direction are provided in the second facing surface portion,
the first positioning portion includes the first protrusions, and
the second positioning portion includes the second protrusions.

4. The lens unit according to claim 3, wherein
the second lens barrel includes, between an end portion of the outer peripheral surface on the object side and the first step portion, a second step portion having a second annular surface that faces the image side and a second outer peripheral surface portion that extends from an inner peripheral end of the second annular surface to the image side,
the first lens barrel includes, on the inner peripheral surface, a first lens barrel-side step portion having an annular first facing surface that faces the second annular surface and a step portion wall surface that extends from an inner peripheral end of the first facing surface to the image side, and
the adhesive layer is interposed between the second annular surface and the first facing surface and between the second outer peripheral surface portion and the step portion wall surface.

5. The lens unit according to claim 4, wherein
the first lens barrel-side step portion has, at a plurality of positions in the circumferential direction, notched grooves that extend in the optical axis direction and divide the first facing surface and the step portion wall surface in the circumferential direction.

6. The lens unit according to claim 5, comprising
an O-ring that is provided on an outer peripheral side of the second lens barrel and is in contact with the first lens from the image side, wherein
the first lens barrel has an annular caulking portion that is bent from a tip portion of the first lens barrel on the object side to the inner peripheral side and is in contact with an outer peripheral end portion of the first lens from the object side, and an annular support surface that faces the object side at a position overlapping with the caulking portion as viewed from the optical axis direction,
the outer peripheral end portion of the first lens is located between the caulking portion and the support surface,
the O-ring is compressed in the optical axis direction between the outer peripheral end portion of the first lens and the support surface,
the second facing surface portion extends from an inner peripheral end of the support surface to the image side, and
an air passage is formed between the first lens barrel and the second lens barrel, the air passage passing through a gap between an end of the first lens barrel on the image side and an end of the second lens barrel on the image side, a gap between the first protrusions adjacent to each other in the circumferential direction, the notched grooves, and a gap between the second protrusions adjacent to each other in the circumferential direction, the air passage communicating with a space that is located between the first lens and the support surface and is closer to the inner peripheral side than the O-ring.
